(19) United States
(12) Patent Application Publication
(10) Pub. No.: US 2012/0006184 A1
(43) Pub. Date: Jan. 12, 2012

(54) Reproduction of Sound of Musical Instruments by Using Fiber Optic Sensors

(75) Inventors: Michele Giordano, Naples (IT); Andrea Cusano, Caserta (IT)

(73) Assignee: OPTOADVANCE S.R.L., 86021 Bojano (CB) (IT)

(21) Appl. No.: 13/255,939

(22) PCT Filed: Mar. 4, 2010
(86) PCT No.: PCT/IT10/00094

§ 371 Date: Sep. 12, 2011

(30) Foreign Application Priority Data
Mar. 16, 2009 (IT) BN2009A000003

(51) Int. Cl. G10H 3/06

(52) U.S. Cl. 84/724

(57) ABSTRACT

The present invention proposes a new system for reproducing of sound of musical instruments through the detection of acoustic vibrations by using fiber optic sensors, preferably fiber Bragg gratings. This system has the potential to be immune to radio-frequency interference and may provide a faithful representation of the instrument's acoustic spectrum without distorting the sound of the instrument.

### BACKGROUND

A musical instrument is a device that is able to generate musical vibrations and launch them into the air. Musical instrument sounds are generated in various ways including the setting into motion of one or more strings mounted on the instrument body; an instrument body or stretched membrane set into vibration by external percussion; or the blowing of air through a series of air columns, cavities, channels or reeds. These vibrations are transmitted from the instrument through the air and are received by the human ear at an intensity determined by the distance between the instrument and the receiver.

In instances where an amplification of the instrument sound or the conversion of the sound in an electrical signal is required, an audio microphone can be placed in close proximity to the instrument body to pickup the vibrations and electrically transmit the sounds to an amplification system. In some instances, it is desired to isolate the instrument from its immediate surrounding and provide single channel amplification through the use of a contact microphone, or acoustic transducer, which is affixed directly to the instrument to pick up the vibrations in the body.

Conventionally, acoustic vibrations of musical instruments are sensed, for reproduction and/or recording purposes, using pickups, i.e., transducers that are sensitive to mechanical vibration in the acoustic frequency range (from 5 Hz to 20 kHz). Such sensors are typically piezoelectric devices that are placed on the soundboard or another vibrating part of the instrument. On the other hand, solid-body electric guitars and similar instruments are almost always equipped with magnetic pickups, which record the mechanical vibration of the metallic strings using electromagnetic induction.

Each conversion and/or amplification method previously cited has a number of significant drawbacks.

Although the use of audio microphones provides the best frequency response and are extensively used in the broadcast, recording and sound reinforcement media, they are best suited for situations involving semi-fixed positions and are not convenient in portable, highly mobile circumstances. Microphones amplify the surrounding environment in addition to the specific instrument, and are highly prone to uncontrolled feedback, in which the amplified sound from the speaker is fed back through the microphone, causing an objectionable squealing sound.

Contact microphones (vibration transducers) must be placed at a point on the instrument body that optimizes the total sound of the instrument, which is often non-existent since each part of the body consists of different material thickness, varying compliance and other mechanical factors. Furthermore, an high-quality pickup introduces an inertial mass to the soundboard, which can have a deleterious effect on the sound obtained. For example, piezoelectric pickups, which may be light and small enough to not have a substantial effect on the sound generated by a large instrument, such as a guitar, are nevertheless unsuitable for use with small instruments, such as flutes, recorders, and harmonicas, because of their size and mass.

Magnetic pickups are no flat in their frequency response capabilities and are basically non-linear devices. The alignment of strings over respective magnetic pole pieces is continually changing and the coils of wire within the pickup induce extraneous noise and hum into the musical signal.

The most serious drawback of all these methods involves the need to use electrical cable between the instrument pickup and the amplification system some distance away. A shielded electrical cable can be thought of as a series of inductive and capacitive elements which act as a series of low pass filters rolling off high frequencies as the cable distance increases. In addition, electrical cables also induce noise and hum as well as significant audio signal delays.

### OBJECT

It is an object of the present invention to provide a system that may solve at least part of the above described problems, or at least provide the public with a useful choice. The present invention, in line of principle, eliminates the need of external microphones and of magnetic or other conventional pickups and also of electrical cables between the instrument pickup and the amplification system.

### DESCRIPTION

The present invention proposes a new system for musical instruments sound reproduction based on use of fiber optic sensors as acoustic transducers.

The system object of this invention firstly includes a Fiber Optic Bragg Grating (FBG) sensor to pickup instrument body vibrations.

The system object of this invention includes placing and attaching a FBG sensor onto the resonating body of a musical instrument in a location where the Bragg grating experiences the acoustic vibration.

The system object of this invention also includes an optical signal emitter for emitting an optical signal toward the sensor.

The system object of this invention further includes an optical signal analyzer for receiving and analyzing the optical signal from the acoustic FBG sensor.

Preferably, both the emitter and the analyzer are connected to the FBG sensor and the optical signal, containing the information related to the acoustic vibration, is the signal reflected by the FBG towards the analyzer.

A FBG is a portion of an optical fibre where the core refractive index is periodically modulated. The FBG reflects light within a particular wavelength range, which depends upon the effective refractive index and the spatial periodicity of the refractive index variation (the grating period), while light out of this wavelength range will pass through the grating more or less unhindered. The characteristic wavelength range reflected by the FBG will exhibit a shift, which is function of external quantities that are able to change the effective refractive index of the optical fiber and/or the actual fiber's length of the grating zone (the actual grating period). Changes in either the tension in the fiber or the environment temperature will therefore lead to shift in the wavelength of the optical signal reflected by the FBG. This is the way because FBGs are today extensively used as transducers in measurements of vibration, strain and temperature.

In acoustic applications, their large acoustic frequency response range is especially beneficial. FBGs are able of measuring mechanical frequencies from the static strain to the MHz range. This invention exploits the sensitivity of FBGs to mechanical deformation to pickup instrument body vibrations; hence, to pickup and transduce sound signals in electrical ones.

A FBG attached to the resonating body of a musical instrument may be expected to faithfully follow all mechanical motions of the body with a flat frequency response in the human acoustic range.

Of critical importance to the intended use as an acoustic transducer is the fact that an FBG is a near-zero mass device and FBG is not sensible or respond to electromagnetic interferences. Furthermore, it is possible to incorporate several FBG transducers onto a single instrument without cross talk effects. The capability to introduce many of these acoustic sensors into different zones of the instrument body would give the musician an unprecedented level of acquisition over the instrument's overall tones.

To use a FBG as a mechanical sensor in addition to the optical fibre where the FBG is realized, usually, but not exhaustively, is needed:

A broadband light source (the emitter) to power the optical fibre where the FBG is realized.
An optical signal interrogator system (the reader system), connected to the optical fibre where the FBG is realized, who receives the optical reflected signal from the FBG and converts the wavelength shift of the reflected optical signal into an amplitude modulated electrical signal. The reader system is also equipped with an analogical audio amplifier circuit to condition the output signal for sound reproducing or recording.

The reader system can be also connected to more than one FBG sensor and can receive all reflected signals and further detect the shift in the wavelength of each reflected optical signal. Usually the emitter and the reader system are parts of a unique FBG interrogator system. The previous description is merely of example and is in no way intended to limit the invention, its application, or uses.

Of critical importance is the fact that the optical fiber that connects FBG sensors to the FBG interrogator is light and flexible and is not affected by external electromagnetic interferences and/or disturbs.

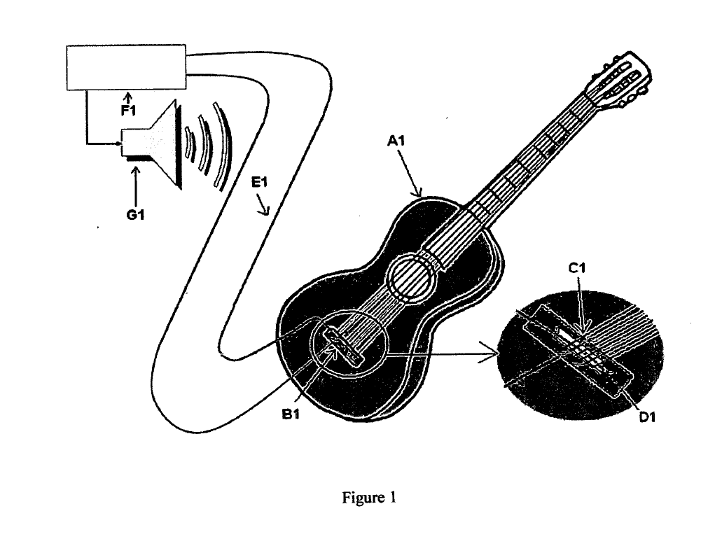

FIG. 1 shows a schematic representation of two fiber Bragg sensors (B1) attached onto a classical (acoustic) guitar (A1), one attached onto a string (C1) and the other one attached onto the bridge (D1). FBGs are connected (E1) to an optical signal interrogator (F1), whose output is then reproduced by a loudspeaker (G1).

FIG. 2 illustrates working principles of a Bragg grating (A2) useful in the system of FIG. 1.

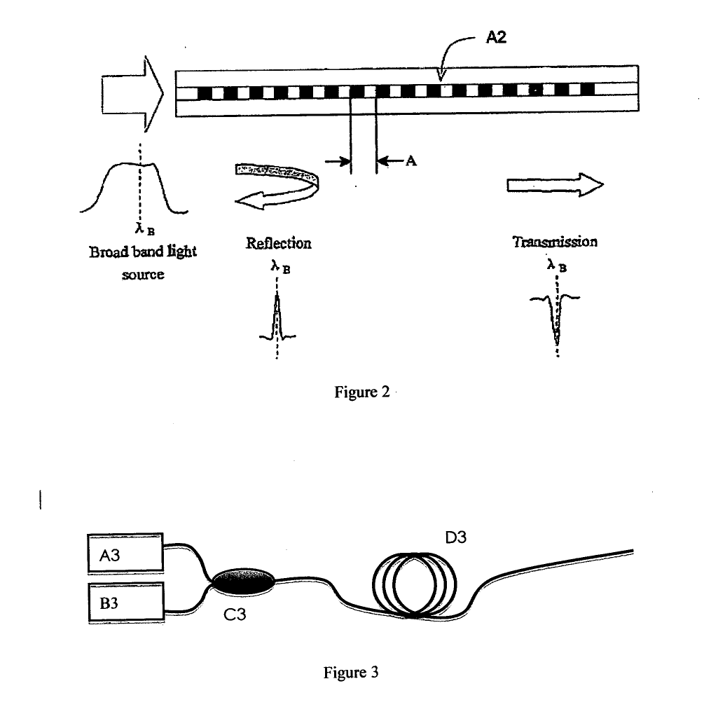

FIG. 3 depicts the block diagram of a FBG interrogator system where A3 is the optical signal emitter, B3 the optical signal from the sensor analyser, both of them are connected to the D3 optical fiber containing the FBG sensor by the Y joint C3

1. A musical instruments sound reproducing system based on fiber optic sensors, for use with a musical instrument having a resonating body, said system comprising:
at least one fiber Bragg grating sensor as acoustic transducer to pick up instrument body vibration;
placing and attaching said at least one fiber Bragg grating sensor onto said resonating body in at least a location where the Bragg grating experiences an acoustic vibration, said fiber Bragg grating sensor generating an optical reflected signal;
an optical signal emitter for emitting an optical signal into said at least one fiber Bragg grating sensor;
an optical signal analyzer for receiving and analyzing the optical reflected signal from the fiber Bragg grating sensor;
wherein the fiber Bragg grating sensor is used as a mechanical sensor to pick up instrument body vibrations and hence, to pick up and transducer sound signals in electrical ones.

2. (canceled)

3. (canceled)

4. (canceled)

5. (canceled)

6. (canceled)

7. (canceled)

8. A system according to claim 1, wherein said optical signal analyzer converts the wavelength shift of the reflected optical signal into an amplitude modulated electrical signal.

9. A system according to claim 8, wherein the optical signal analyzer is connected to more than one fiber Bragg grating sensor, wherein the optical signal analyzer receives all reflected signals, and wherein the optical signal analyzer further detects the shift in the wavelength of each reflected optical signal.

10. A system according to claim 8, wherein the optical signal analyzer comprises an analogical audio amplifier circuit for conditioning the output of the amplitude modulated electrical signal.

11. A system according to claim 10, wherein the optical signal analyzer is connected to more than one fiber Bragg grating sensor, wherein the optical signal analyzer receives all reflected signals, and wherein the optical signal analyzer detects the shift in the wavelength of each reflected optical signal.

12. A system according to claim 1, comprising a broadband light source to power the optical fiber where the fiber Bragg sensor is realized.

13. A system according to claim 1, further comprising:
said optical signal analyzer converting the wavelength shift of the reflected optical signal into an amplitude modulated electrical signal; and
a broadband light source to power the optical fiber where the fiber Bragg sensor is realized.

14. A system according to claim 1, further comprising said optical signal analyzer converting the wavelength shift of the reflected optical signal into an amplitude modulated electrical signal, wherein the optical signal analyzer is connected to more than one fiber Bragg grating sensor, wherein the optical signal analyzer receives all reflected signals, and wherein the optical signal analyzer further detects the shift in the wavelength of each reflected optical signal, and wherein the optical signal analyzer comprises an analogical audio amplifier circuit for conditioning the output of the amplitude modulated electrical signal.

15. A system according to claim 14, comprising a broadband light source to power the optical fiber where the fiber Bragg sensor is realized.

16. A method for transducing sound signals from mechanical deformations utilizing the system according to claim 1.

17. A musical instrument comprising:
a sound generator generating acoustic vibrations;
a resonating body resonating said acoustic vibrations; and
a fiber Bragg grating sensor attached to the resonating body.

18. The musical instrument of claim 17, wherein the fiber Bragg grating sensor senses mechanical deformation of the resonating body and generates an optical reflected signal.

19. The musical instrument of claim 18, further comprising an optical signal analyzer for receiving the optical reflected signal from the fiber Bragg grating sensor and for converting the wavelength shift of the optical reflected signal into an amplitude modulated electrical signal.

20. The musical instrument of claim 19, further comprising an analogical audio amplifier circuit to condition the amplitude modulated electrical signal for sound reproduction.
